(19) United States
(12) Patent Application Publication
(10) Pub. No.: US 2009/0205037 A1
(43) Pub. Date: Aug. 13, 2009

(54) Mobile terminal, resource access control system for mobile terminal, and resource access control method in mobile terminal

(75) Inventor: Yoshiharu Asakura, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: NEC CORPORATION, TOKYO (JP)

(21) Appl. No.: 11/630,660

(22) PCT Filed: Jun. 24, 2005
(86) PCT No.: PCT/JP05/12257

§ 371 Date: Apr. 11, 2007

(30) Foreign Application Priority Data
Jun. 25, 2004 (JP) 2004-188361

(51) Int. Cl. G06F 21/20; H04L 9/00; G06F 17/30

(52) U.S. Cl. 726/10; 707/9; 707/200; 707/100; 707/E17.005; 707/E17.044

(57) ABSTRACT

The present invention provides a mobile terminal, a resource access control system for a mobile terminal, and a resource access control method in a mobile terminal which can flexibly change resources that can be accessed by an application. An application manager 118 of a mobile terminal 101 transmits an identifier of a root certificate of an application to a server 102 at predetermined timing, e.g., when the application is started, to thereby retrieve a corresponding resource list from a resource database 122. The corresponding resource list is added to an access database 115, or the contents of the access database 115 are updated with the corresponding resource list. Access to resources specified by the resource list is permitted. When the resource list is changed, the contents of the resource list may be transmitted from the server 102 to the mobile terminal 101 by a push type notification.

### TECHNICAL FIELD

The present invention relates to a mobile terminal having additional application software in addition to software for processing a function inherent in a telephone, such as a cellular phone, a resource access control system for such a mobile terminal, and a resource access control method in a mobile terminal, and more particularly to a control of propriety of access when application software requests use of a resource provided in a mobile terminal.

### BACKGROUND ART

Available resources for application software (hereinafter simply referred to as application) are desired to be restricted in some cases. Generally, in order to achieve this, applications are grouped, and available resources are restricted for each group. This is because if available resources are restricted for each application, then available resource definitions are needed in proportion to the number of applications to thereby cause a high operational cost.

Grouping of applications is generally conducted by types of root certificates for verifying digital certificates attached to applications. (Root certificates are issued by a certificate authority as a trusted third party.) Accordingly, a group of an application is defined by a type of a root certificate for verifying certificates, and an access control is performed in accordance with an available resource definition defined for that group.

Thus, available resources for applications may be restricted depending upon types of root certificates. For example, it is assumed that geographic software is installed as an application on a mobile terminal such as a cellular phone, a Personal Handy-phone System (PHS), or a Personal: Digital Assistant (PDA). When the mobile terminal is provided with a Global Positioning System (GPS), the GPS may be included in available resources indicated by one root certificate but not in available resources indicated by another root certificate even with the same application. The application can access the GPS in the former case but not in the latter case.

Conventionally, when a mobile terminal was to be shipped, root certificates used to verify certificates attached to applications were associated with resource lists, which were lists of resources that could be accessed by respective applications, in the mobile terminal. When an application was to be started, propriety of access to respective resources was controlled within the mobile terminal based on the relationship between the root certificates and the resource lists. Accordingly, when resources were added in the mobile terminal after the shipping of the mobile terminal or the number of root certificates was increased or decreased in the mobile terminal, the relationship of the accessible resource lists could not be changed. Thus, when applications were used in the mobile terminal, the applications had a difficulty in operation due to presence of resources that could not be accessed.

Meanwhile, with regard to applications downloaded to a mobile terminal from a network, it is substantially difficult to completely assure the reliability to those applications. Accordingly, an access restriction to resources in the mobile terminal has heretofore been performed for such applications. Such a standardized access restriction may result in impaired convenience of applications in some cases.

Japanese laid-open patent publication No. 2002-344623 discloses the following access method in a case of executing an application obtained via a network. With regard to a resource defined so as to be accessed according to execution of an application, access to that resource is permitted under such conditions that the application and an application for the resource are simultaneously obtained via a network while the resource is the same as it was when the applications were obtained.

In this method, if a combination of a portable terminal and a user identify module (UMI) used as a resource in the portable terminal is the same as it was when a pair of an application for the portable terminal and an application for the user identify module was simultaneously downloaded from the network, then access to subscriber information stored in the user identify module from a cellular phone is permitted by operating an application for the cellular phone and an application for a user identify module corresponding to the cellular phone in conjunction with each other during a process of the application for the portable terminal. However, this proposal can be used only in a technical environment in which an application for a main device and an application for a user identify module are operated in conjunction with each other. Thus, the aforementioned problem that applications have a difficulty in operation cannot be solved.

### DISCLOSURE OF INVENTION

Therefore, an object of the present invention is to provide a mobile terminal, a resource access control system for a mobile terminal, and a resource access control method in a mobile terminal which can flexibly change resources that can be accessed by an application.

According to the present invention, there is provided a mobile terminal including application storage means for storing application software programs to be used, resource list request means for requesting a resource list including resources that can be accessed by an application software program stored in the application storage means to an external device based on information indicative of a root certificate used to verify a certificate attached to the application software program at predetermined timing of use of the application software program, and resource access control means for determining a resource that can be accessed by the application software program with use of the resource list acquired by the request of the resource list request means.

Specifically, resource lists are managed by an external device. A corresponding resource list is acquired from the external device based on information indicative of a root certificate used to verify a certificate attached to an application software program at predetermined timing of use of the application software program. Since the resource access control means determines a resource that can be accessed by the application software program with use of the acquired resource list, it is possible to cope with addition or change of resources flexibly.

Further, according to the present invention, there is provided a mobile terminal including application storage means for storing application software programs to be used, resource list acquisition means for transmitting an identifier of a root certificate used to verify a certificate attached to an application software program stored in the application storage means to a predetermined server at predetermined timing of use of the application software program and acquiring a resource list including resources that can be accessed by the application software program with use of a key of the identifier of the root certificate, and resource access control means for determining a resource that can be accessed by the application software program with use of the resource list acquired by the resource list acquisition means.

Specifically, resource lists are managed by an external device. A corresponding resource list is acquired from the external device based on an identifier of a root certificate used to verify a certificate attached to an application software program at predetermined timing of use of the application software program. Since the resource access control means determines a resource that can be accessed by the application software program with use of the acquired resource list, it is possible to cope with addition or change of resources flexibly.

Further, according to the present invention, there is provided a resource access control system for a mobile terminal, which includes a mobile terminal including application storage means for storing application software programs to be used, resource list request means for requesting a resource list including resources that can be accessed by an application software program stored in the application storage means to an external device based on an identifier of a root certificate used to verify a certificate attached to the application software program at predetermined timing of use of the application software program, and resource access control means for determining a resource that can be accessed by the application software program with use of the resource list acquired by the request of the resource list request means, and a server including a resource database for storing resource lists including resources that can be accessed by various application software programs in association with an identifier of a root certificate, resource database retrieval means for performing retrieval from the resource database when the resource list request means of the mobile terminal requests a resource list with a specified identifier of a root certificate, and resource list transmission means for transmitting the resource list acquired by the retrieval of the resource database retrieval means to the requesting mobile terminal.

Specifically, the mobile terminal is provided with resource list request means for requesting a resource list including resources that can be accessed by an application software program to an external device based on an identifier of a root certificate used to verify a certificate attached to the application software program at predetermined timing of use of the application software program. The server is provided with a resource database storing pairs of an identifier and a resource list in association with each other. When an identifier of a root certificate is transmitted from the mobile terminal, a corresponding resource list is transmitted to the mobile terminal. In the mobile terminal, a resource that can be accessed by the application software program is determined with use of the acquired resource list.

Furthermore, according to the present invention, there is provided a resource access control method in a mobile terminal, which includes a resource list acquisition request step of transmitting, to a predetermined server, an identifier of a root certificate used to verify a certificate attached to an application software program at predetermined timing of use of the application software program in a mobile terminal and requesting acquisition of a resource list including resources that can be accessed by the application software program, a retrieval result transmission step of retrieving a resource list from a resource database storing resource lists including resources that can be accessed by various application software programs in association with the respective application software programs with use of a key of the identifier of the root certificate transmitted in the resource list acquisition request step and transmitting the resource list from a server to the requesting mobile terminal, and a resource access control step of determining a resource that can be accessed by the application software program with use of the resource list transmitted from the server to the mobile terminal in the retrieval result transmission step.

Specifically, the mobile terminal requires acquisition of a resource list including resources that can be accessed by an application software program with use of an identifier of a root certificate at predetermined timing of use of the application software program in a resource list acquisition request step. The server retrieves a resource list from a resource database storing resource lists including resources that can be accessed by various application software programs in association with the respective application software programs with use of a key of the transmitted identifier of the root certificate in a retrieval result transmission step and transmits the corresponding resource list from the server to the requesting mobile terminal. The mobile terminal determines a resource that can be accessed by the application software program with use, of the resource list transmitted from the server to the mobile terminal.

Further, according to the present invention, there is provided a mobile terminal including application storage means for storing application software programs to be used, a database for storing pairs of an identifier of a root certificate used to verify a certificate attached to an application software program stored in the application storage means and a resource list including resources that can be accessed by the application software program in association with each other, receiving means for receiving a pair of an identifier of a root certificate transmitted from an external device and a resource list including resources that can be accessed by an application software program, database update means for updating the database when the identifier received by the receiving means is an identifier of a root certificate used to verify a certificate attached to the application software program stored in the application storage means, retrieval means for retrieving a resource list corresponding to an identifier of a root certificate used to verify a certificate attached to an application software program from the database when the application software program is started, and resource access control means for determining a resource that can be accessed by the application software program with use of the resource list retrieved by the retrieval means.

Specifically, this is a case in which a push type notification is transmitted from an external device when a resource list is changed. The mobile terminal has a database for storing pairs of an identifier of a root certificate used to verify a certificate attached to an application software program and a resource list including resources that can be accessed by the application software program in association with each other, and updates its contents by push notification of addition, change, or the like. A resource list corresponding to an identifier of a root certificate used to verify a certificate attached to an application software program is retrieved from the database when the application software program is started. A resource that can be accessed by the application software program is determined based on the retrieval result.

Further, according to the present invention, there is provided a resource access control system for a mobile terminal, which includes a server including a database for storing pairs of an identifier of a root certificate and a resource list including resources that can be accessed by an application software program in association with each other, and resource list change transmission means for transmitting a resource list to a predetermined destination together with the identifier of the root certificate when the resource list is changed, and a mobile terminal including application storage means for storing application software programs to be used, a database for storing pairs of an identifier of a root certificate used to verify a certificate attached to an application software program stored in the application storage means and a resource list including resources that can be accessed by the application software program in association with each other, receiving means for receiving a pair of an identifier of a root certificate transmitted from the server and a resource list including resources that can be accessed by an application software program, database update means for updating the database when the identifier received by the receiving means is an identifier of a root certificate used to verify a certificate attached to the application software program stored in the application storage means, retrieval means for retrieving a resource list corresponding to an identifier of a root certificate used to verify a certificate attached to an application software program from the database when the application software program is started, and resource access control means for determining a resource that can be accessed by the application software program with use of the resource list retrieved by the retrieval means.

Specifically, the server forms an external device and transmits a resource list to a predetermined mobile terminal when the resource list is changed.

As described above, according to the present invention, information indicative of a root certificate, such as an identifier of the root certificate, and information associated with a resource list are stored in an external device such as a server that can be accessed by the mobile terminal. The information is transmitted to the mobile terminal in response to request, or transmitted from the external device to the mobile terminal when the contents of the resource list are changed. Accordingly, by requesting a resource list to the external device at predetermined timing, e.g., each time the mobile terminal starts the application, it is possible to control access to resources in the mobile terminal based on latest resource lists at the time of the request.

Further, according to the present invention, information indicative of a root certificate, such as an identifier of the root certificate, and information associated with a resource list are stored in an external device such as a server so that access to resources can be controlled. Accordingly, it is not necessary to prepare available resource lists for respective applications in the mobile terminal. Further, according to the present invention, use of an identifier of a root certificate can eliminate the necessity to locate the root certificate in an external device such as a server. This is because the identifier of the root certificate can be used to determine identity of the root certificate.

### BRIEF DESCRIPTION OF DRAWINGS

FIG. 1 is a system configuration diagram schematically showing a configuration of a resource access control system according to a first embodiment of the present invention;

FIG. 2 is a flow chart showing a process of a mobile terminal when an application is started in the first embodiment;

FIG. 3 is a flow chart showing a process of a server in the first embodiment;

FIG. 4 is a flow chart showing a process of the mobile terminal when a resource list is transmitted from a server communication device in the first embodiment;

FIG. 5 is a flow chart showing a process of the mobile terminal when a certain resource is used during execution of an application in the first embodiment;

FIG. 6 is a system configuration diagram of a resource access control system according to a second embodiment, in which a mobile terminal is applied to a cellular phone;

FIG. 7 is an explanatory diagram showing a state of a resource access control system before update in a third embodiment;

FIG. 8 is an explanatory diagram showing a state of the resource access control system after update in the third embodiment;

FIG. 9 is a flow chart showing a process of a server in a variation of the present invention; and

FIG. 10 is a flow chart showing an update process of an access database in a mobile terminal in a variation of the present invention.

### BEST MODE FOR CARRYING OUT THE INVENTION

The present invention will be described in detail with embodiments and the drawings.

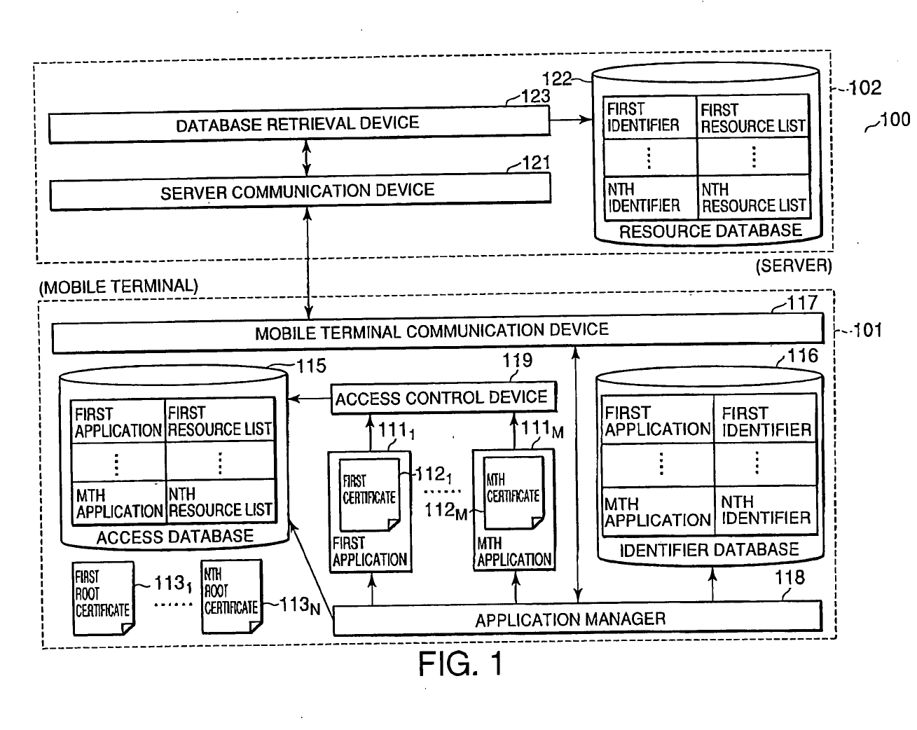

FIG. 1 schematically shows a configuration of a resource access control system according to an embodiment of the present invention. This resource access control system 100 is formed by a mobile terminal 101 and a server 102. For brevity, only one mobile terminal 101 is illustrated in FIG. 1. The mobile terminal 101 has a central processing unit (CPU), a control program storage unit for storing various control programs executed by the CPU, a RAM for temporarily storing various data for processing, and a storage medium for creating various databases, such as a flash memory having a relatively large capacity, which are not shown in the drawings.

First to Mth application software programs (hereinafter simply referred to as applications) 111₁ to 111_{M} for implementing various functions with software are stored in the storage medium within the mobile terminal 101. First to Mth certificates 112₁ to 112_{M} are attached to the respective applications. First to Nth (M>N) root certificates 113₁ to 113_{N} used to verify the first to Mth certificates 112₁ to 112_{M} are stored in the storage medium. Two types of databases including an access database 115 and an identifier database 116 are prepared within the mobile terminal 101. An application manager 118 is operable to control a mobile terminal communication device 117 for communicating between these databases, the first to Mth applications 111₁ to 111_{M}, and the server 102. An access control device 119 for controlling access to resources from applications is connected to the access database 115.

Pairs of Identifiers of the first to Mth applications 111₁ to 111_{M} and first to Nth resource lists are stored in association with each other in the access database. Further, pairs of identifiers of the first to Mth applications 111₁ to 111_{M} and first to Nth identifiers of root certificates used to verify certificates attached to the first to Mth application 111₁ to 111_{M} are stored in association with each other in the identifier database 116.

The mobile terminal communication device 117 connected to the application manager 118 is configured to communicate with a server communication device 121 in the server 102. In addition to the server communication device 121, a resource database 122 including resources and a database retrieval device 123 for retrieving resources from the resource database are disposed in the server 102. The resource database 122 stores pairs of first to Nth identifiers as identifiers of root certificates and first to Nth resource lists as lists of resources that can be accessed by applications. Here, each resource list is formed as a subset of a first resource to an Lth resource.

The database retrieval device 123 is operable to retrieve an accessible resource list from the resource database 122 with use of a key of an identifier of a root certificate received from the mobile terminal 101. A resource list obtained as a retrieval result is transmitted from the server communication device 121 via the mobile terminal communication device 117 to the access database 115 and stored in the access database 115 in association with an application. The application manager 118 is operable to start the first to Mth applications 111₁ to 111_{M} and retrieve an identifier of a root certificate used to verify a certificate attached to the started application from the identifier database 116 with use of a key of the application. Further, the application manager 118 is configured to add or update a combination of an application and a resource list in the access database 115.

Meanwhile, it is assumed that data indicating a combination of an Xth application 111_{X} (X is an integer between 1 and M) and a Yth identifier as an identifier of a Yth root certificate 113_{Y} used to verify an Xth certificate 112_{X} attached to the Xth application 111_{X} are stored in the identifier database 116 of the mobile terminal 101.

An application A is operated in the mobile terminal 101. Here, the application A is any one of the first to Mth applications 111₁ to 111_{M}.

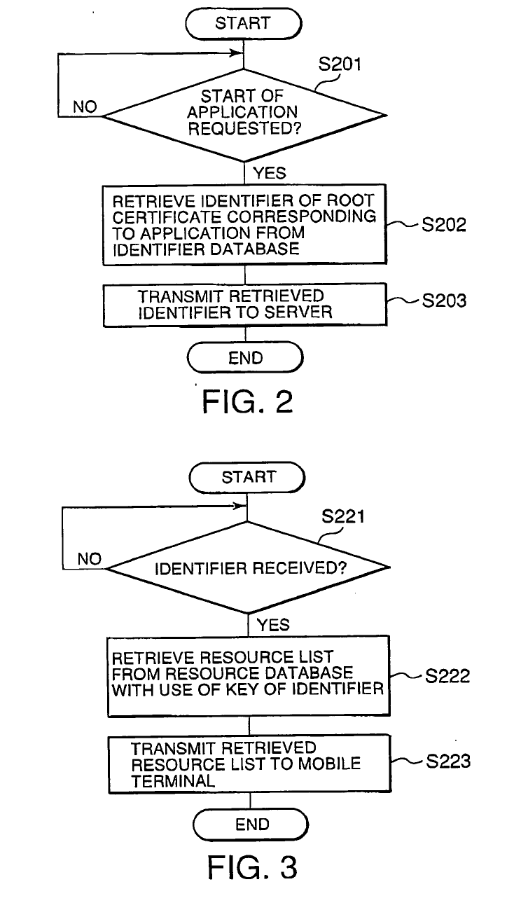

FIG. 2 shows a process in the mobile terminal when an application is started. It is assumed that a user conducts a predetermined input operation or the like on the mobile terminal 101 so as to command a desired application (the application A in this example) to be started (Step S201: Y). Then the application manager 118 shown in FIG. 1 retrieves an identifier A as an identifier of a root certificate corresponding to the application A from the identifier database 116 before starting the application A (Step S202). The application manager 118 transmits the retrieved identifier A to the server 102 via the mobile terminal communication device 117 (Step S203).

FIG. 3 shows a process flow of the server. The server communication device 121 in the server 102 waits for an identifier of: a root certificate of an application, which is commanded to be started, to be transmitted from the mobile terminal 101 (Step S221). In this example, the identifier A corresponding to the application A is transmitted (Y). When the identifier A is received, the database retrieval device 123 retrieves a corresponding resource list from the resource database 122 with use of a key of the identifier A (Step S222). In this example, a resource list A, which is an Ath resource list, is retrieved. The server communication device 121 transmits the retrieved resource list A to the mobile terminal 101 as a client (Step S223).

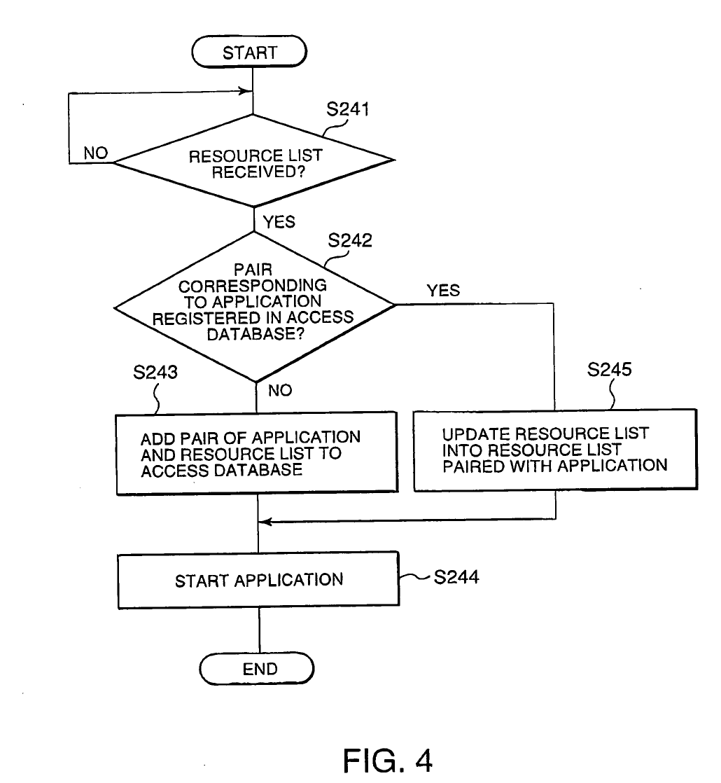

FIG. 4 shows a process of the mobile terminal when a resource list is transmitted from the server communication device. When the mobile terminal communication device 117 in the mobile terminal 101 receives the resource list A (Step S241: Y), the application manager 118 examines whether a pair corresponding to the application has been registered in the access database 115 (Step S242). In this example, the application manager 118 examines whether a pair corresponding to the application A has been registered in the access database 115.

As a result, if it is determined that a pair corresponding to the application A has not been registered in the access database 115 (N), the application manager 118 adds a pair of the application A and the resource list A to the access database 115 in this example (Step S243). Then the application A is started (Step S244).

On the other hand, it is assumed that a pair corresponding to the application A has been registered in the access database 115 in Step S242 (Y). In this case, an update process is performed so as to replace a resource list of the pair that has already been registered in the access database 115 with the resource list A paired with the application A (Step S245). Then the application A is started (Step S244).

Next, there will be described a case in which the application A is to use a resource B as a certain resource during execution of the application A. Here, the resource B is any one of first resource to the Lth resource.

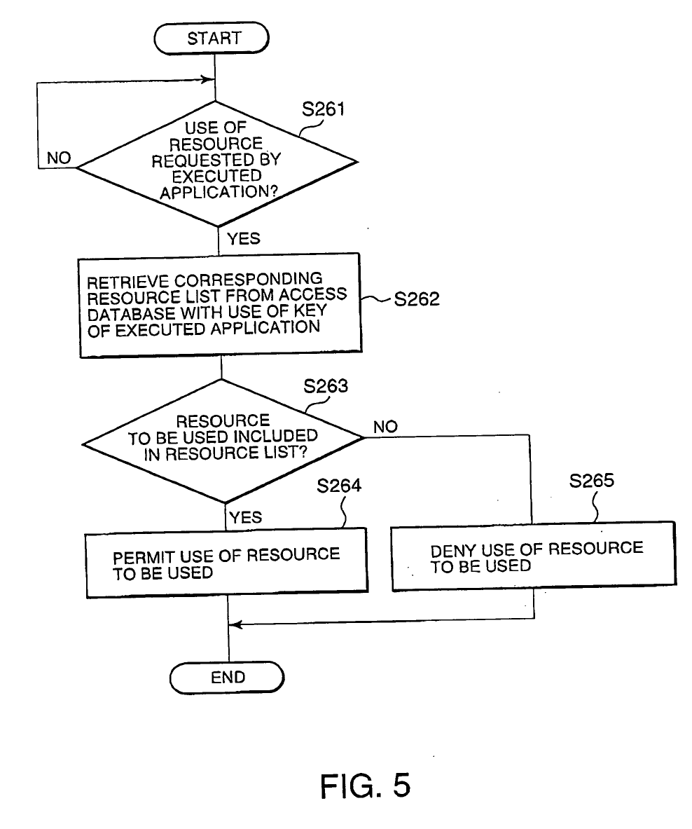

FIG. 5 shows a process of the mobile terminal when a certain resource is used during execution of an application. It is assumed that use of the resource B is requested during execution of the application A (Step S261: Y). The access control device 119 in the mobile terminal 101 retrieves a resource list A corresponding to the application A from the access database 115 with use of a key of the executed application A (Step S262). Then the access control device 119 examines whether the resource list A includes a resource B to be used (Step S263).

As a result of examination, if it is determined that the resource list A includes the resource B (Y), then the use of the resource B is permitted (Step S264). If the resource list A does not include the resource B (Step S263: N), then the use of the resource B is not permitted (Step S265), and the process is terminated (End).

Next, a resource access control system according to a second embodiment of the present invention will be described below with an example in which the mobile terminal is a cellular phone.

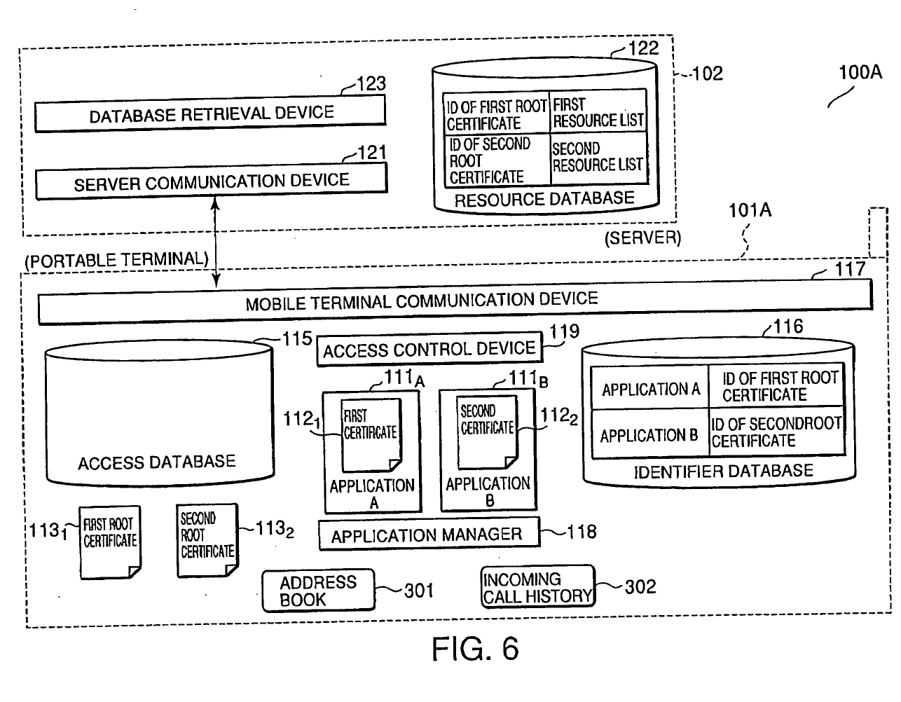

FIG. 6 shows a resource access control system according to a second embodiment of the present invention. In FIG. 6, the same reference numerals are used for the same portions as those in FIG. 1, and the following description is mainly focused on different portions while explanation of the same portions are omitted as needed.

In this example, a cellular phone 101A is used as a mobile terminal, which forms the system. First and second root certificates 113₁ and 113₂ to which a unique identification (ID) is assigned are installed on the cellular phone 101A. Further, an application A to which a first certificate 112₁ to be verified by the first root certificate 113₁ is attached and an application B to which a second certificate 112₂ to be verified by the second root certificate 113₂ is attached are also installed on the cellular phone 101A. A pair of the application A and an ID of the first root certificate 113₁ and a pair of the application B and an ID of the second root certificate 113₂ are stored in an identifier database of the cellular phone 101A. No items are stored in an access database 115 at this time.

On the other hand, a pair of an ID of the first root certificate 113₁ and a first resource list and a pair of an ID of the second root certificate 113₂ and a second resource list are stored in the resource database 122 in the server 102. Here, the first resource list includes an address book and an incoming call history. The second resource list includes a mail and an incoming call history.

In a resource access control system 100A thus arranged, the first resource list includes the address book 301 but not the mail, which is included in the second resource list. Further, the second resource list does not include the address book 301, which is included in the first resource list, but the mail.

It is assumed that a user commands the application A to be started. The application manager 118 retrieves the ID of the first root certificate 113₁ from the identifier database 116 with use of a key of the application A. The application manager 118 transmits the retrieved ID of the first root certificate 113₁ to the server 102 via the mobile terminal communication device 117 (see Step S203 in FIG. 2).

When the server communication device 121 in the server 102 receives the ID of the first root certificate 113₁, the database retrieval device 123 performs retrieval from the resource database 122 with use of a key of the ID of the first root certificate 113₁. Thus, the first resource list is retrieved (see Step S222 in FIG. 3) and then transmitted to the cellular phone 101A.

In the cellular phone 101A, the application manager 118 stores a pair of the first resource list transmitted from the server 102 and the application A into the access database 115. Then the application manager 118 starts the application A. It is assumed that the started application A is to access the address book 301. The access control device 119 retrieves the first resource list from the access database 115 with use of a key of the application A. As described above, the first resource list includes the address book. Accordingly, the access control device 119 permits the application A to access the address book 301.

Next, there will be described a case in which the application A is to access the mail. In this case, the access control device 119 performs retrieval from the access database 115 with use of a key of the application A. Similarly, the first resource list is retrieved. As described above, the first resource list does not include the mail. Accordingly, the access control device 119 denies access to the mail from the application A.

Next, there will be described a case in which a user commands another application B to be started. When a user commands the application B to be started, the application manager 118 performs retrieval from the identifier database 116 with use of a key of the application B. The application manager 118 retrieves the ID of the second root certificate and transmits it to the server 102.

When the ID of the second root certificate is received, the database retrieval device 123 of the server 102 retrieves the corresponding second resource list from the resource database 122 with use of a key of the ID of the second root certificate (see Step S222 in FIG. 3). The retrieved second resource list is transmitted to the cellular phone 101A.

The application manager 118 stores a pair of the application B and the received second resource list into the access database 115. Then the application B is started.

Meanwhile, in a case where the application B is to access the address book, the access control device 119 retrieves the second resource list from the access database 115 with use of a key of the application B. The second resource list does not include the address book 301. Accordingly, the access control device 119 denies access to the address book 301 from the application B. In a case where the application B is to access the mail, the access control device 119 retrieves the second resource list from the access database 115 with use of a key of the application B. On the assumption that the second resource list includes the mail, the access control device 119 permits the application B to access the mail.

Next, a resource access control system according to a third embodiment of the present invention will be described below with an example in which the mobile terminal is a cellular phone, which has a Global Positioning System (GPS) device and a camera device for taking static images or dynamic images.

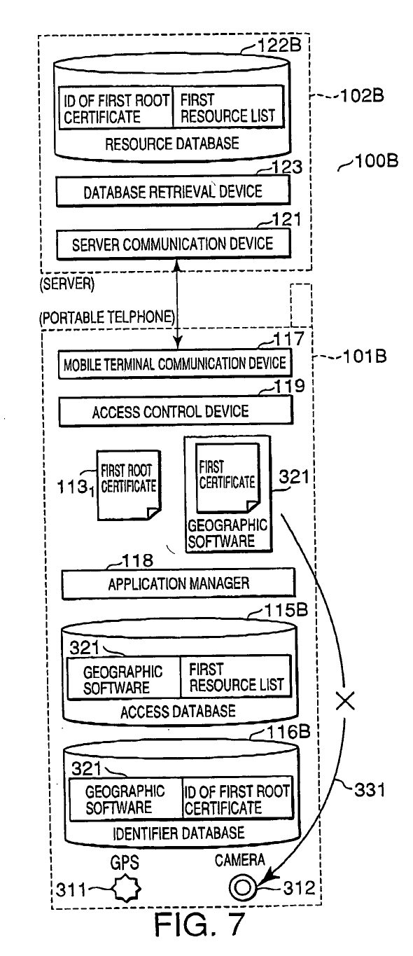

FIG. 7 shows a resource access control system according to a third embodiment. In the resource access control system 100B shown in FIG. 7, the same reference numerals are used for the same portions as those in FIG. 1, and the following description is mainly focused on different portions while explanation of the same portions are omitted as needed. In this example, a cellular phone 101B is used as a mobile terminal, which forms the system. The cellular phone 101B has a body on which a Global Positioning System (GPS) device 311 for detecting the present position and a camera 312 for taking static images or dynamic images are mounted. A certain geographic software program (software) 321 is installed on the cellular phone 101B to employ the GPS device 311. Further, a first root certificate 113₁ to which a unique ID is assigned is installed on the cellular phone 101B. A pair of the geographic software 321 and an ID of the first root certificate 113₁ is stored in an identifier database 116B of the cellular phone 101B. A pair of the geographic software program 321 and a first resource list is stored in an access database 115B.

A server 102B, which communicates with the mobile terminal communication device 117 of the cellular phone 101B via the server communication device 121, has a resource database 122B from which the database retrieval device 123 performs retrieval. A pair of the ID of the first root certificate and the first resource list is stored in the resource database 122B. In this example, the first resource list only includes the GPS.

In the resource access control system 100B thus arranged, it is assumed that a user commands the geographic software program 321 to be started. As described in connection with FIG. 2, the application manager 118 retrieves the ID of the first root certificate 113₁ from the identifier database 116B with use of a key of the geographic software program 321 commanded to be started. Then the application manager 118 transmits the retrieved ID to the server 102B.

In the server 102B, the database retrieval device 123 performs retrieval from the resource database 122B with use of a key of the ID of the first root certificate 113₁. Thus, the first resource list is retrieved, and the server communication device 121 transmits the retrieved first resource list to the cellular phone 101B. The application manager 118 of the cellular phone 101B compares the first resource list transmitted from the server 102B with the first resource list stored as being paired with the geographic software 321 in the access database 115B. In this example, since these resource lists are the same, update of the access database 115B is not performed in the cellular phone 101B.

Then the application manager 118 starts the geographic software program 321. It is assumed that the geographic software program 321 is to access the camera 312 at a certain point of time. In this case, the access control device 119 performs retrieval from the access database 115B with use of a key of the geographic software program 321. Thus, the first resource list is retrieved. The first resource list includes the GPS 311 but not the camera 312. Accordingly, the access control device 119 denies access to the camera 312 from the geographic software program 321 as shown by arrow 331.

Thus, in this example, access to the camera 312 from the geographic software 321 is denied. Next, there will be described a case in which the first resource list is updated into a_first-B resource list having the camera 312 added thereto.

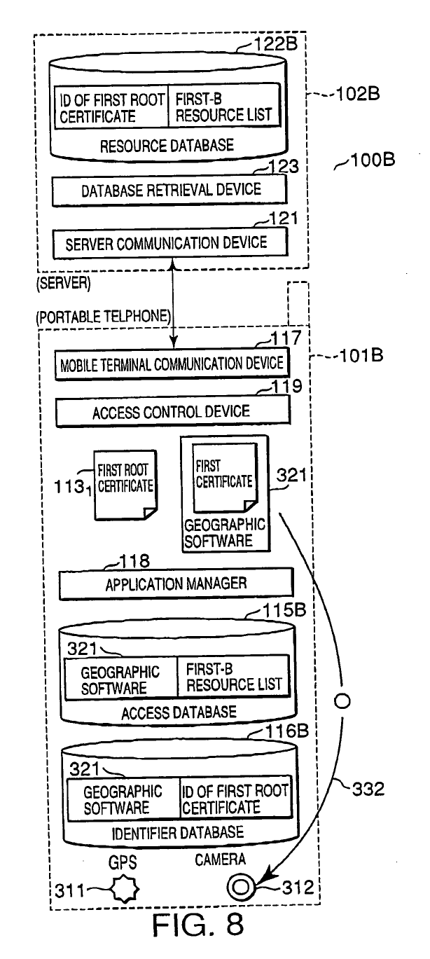

FIG. 8 shows the resource access control system after the first resource list has been updated into the first-B resource list. In FIG. 8, the same reference numerals are used for the same portions as those in FIG. 7. In the resource access control system 100B, as compared to the first resource list shown in FIG. 7, a pair to the ID of the first root certificate in the resource database 122B of the server 102B has been updated into the first-B resource list, to which the camera 312 is added as well as the GPS 311.

Accordingly, when a user commands the geographic software program 321 to be started in a state shown in FIG. 8, the application manager 118 performs retrieval from the identifier database 116B with use of a key of the geographic software program 321. Thus, the ID of the first root certificate is retrieved and then transmitted to the server 102B. In the server 102B, the database retrieval device 123 performs retrieval from the resource database 122B with use of a key of the ID of the first root certificate. In this example, the first-B resource list is retrieved and then transmitted to the mobile terminal 101B.

The application manager 118 of the mobile terminal 101B compares the first-B resource list transmitted from the server 102B with the first resource list currently stored as a pair to the geographic software program 321 in the access database 115B. In this example, the first resource list has been changed into the first B resource list. Accordingly, the application manager 118 updates the first resource list into the first-B resource list.

Then the application manager 118 starts the geographic software program 321. When the geographic software program 321 is to access the camera 312, the access control device 119 performs retrieval from the access database 115B with use of a key of the geographic software program 321. Thus, the updated first-B resource list is retrieved. The first-B resource list includes the camera 312. Accordingly, the access control device 119 permits the geographic software program 321 to access the camera 312 as shown by arrow 332.

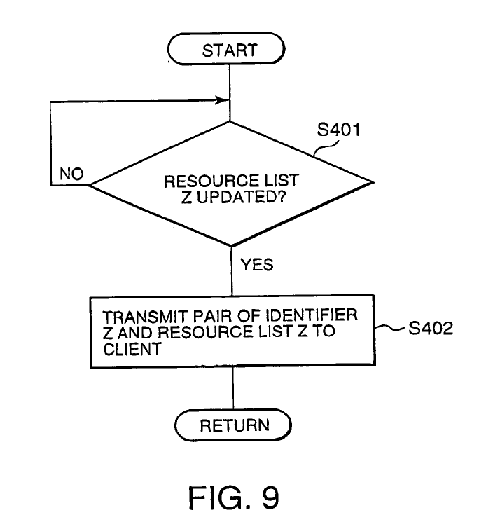

FIG. 9 shows a process of the server in a variation of the present invention. In this variation, the database retrieval device 123 of the server 102 shown in FIG. 1 monitors changes of a resource list Z in the resource database 122 (Step S401). If the resource list is changed (Y), a pair of an identifier Z and the resource list Z is transmitted to a mobile terminal (client) that has previously registered (Step S402).

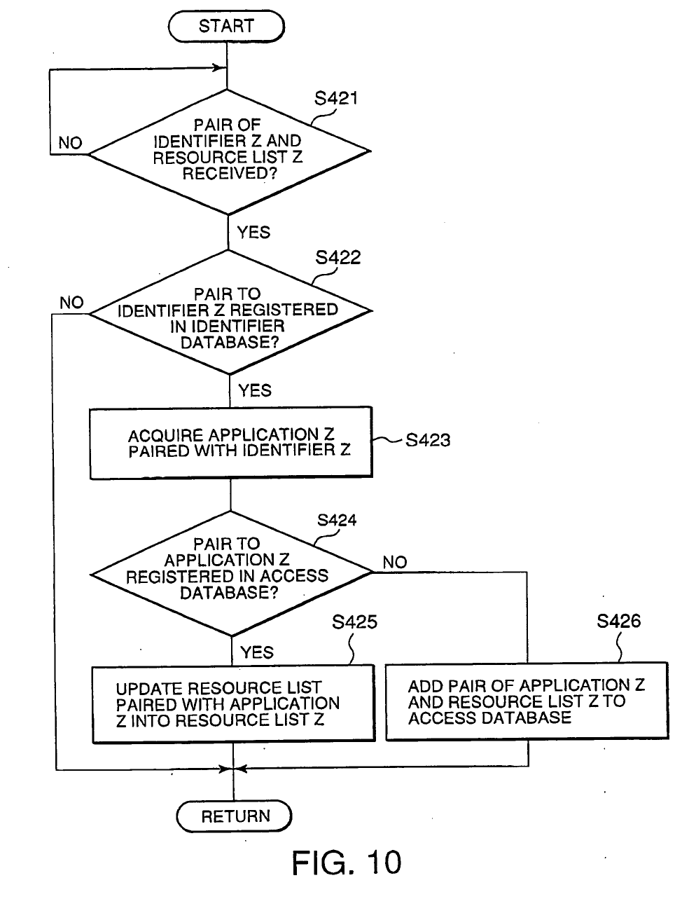

FIG. 10 shows an update process of the access database of the mobile terminal in this variation. In the mobile terminal 101, the mobile terminal communication device 117 shown in FIG. 1 waits for the pair of the identifier Z and the resource list Z to be received from the server 102 (Step S421). When the pair of the identifier Z and the resource list Z is received (Y), it is examined whether the identifier Z has been registered in the identifier database 116 (Step S422). If the identifier Z has not been registered (N), the transmitted resource list is irrelevant to applications installed on the user's mobile terminal 101. In this case, accordingly, no processing is conducted on the access database 116 (Return).

On the other hand, if it is determined in Step S422 that the identifier Z has been registered in the identifier database 116 (Y), then an identifier of the application Z as a pair to the identifier Z is retrieved from the identifier database 116 (Step S423). Then it is examined whether the application Z has been registered in the access database 115 (Step S424). If the application Z has been registered, the resource list is updated into a new resource list because the resource list has been changed (Step S425). On the other hand, if the application Z has not been registered in the access database 115 (Step S423: N), then a pair of the application Z and the resource list Z is added to the access database 115 (Step S426).

Thus, in this variation, push type notifications are sequentially transmitted from the server 102. Accordingly, the mobile terminal 101 can eliminate waste such as redundant acquisition of resource lists that have not been changed from the server 102.

The aforementioned embodiments and variations have been described with using examples of a cellular phone. However, as a matter of course, examples of the mobile terminal include various devices such as a portable personal computer, a car navigation system, and a built-in device, e.g., a clock having a function of communicating with an external device.

In the above embodiments, a resource list is requested to the server each time an application is started. However, once a pair of an application and a resource list is stored in the mobile terminal, it is not necessary to request a resource list to the server each time an application is started. For example, a resource list may be requested once in every two times of starting applications. Alternatively, a resource list may be requested once a day. A resource list may be requested three days after previous acquisition. Thus, the timing of acquisition may be designed as needed.

Further, in the above embodiments, the identifiers of the root certificate have not been descried in detail. However, it is possible to use various identifiers for maintaining identity of the root certificates. For example, it is possible to use, as an identifier Z of a root certificate, the root certificate itself or a hash value into which the root certificate is encoded with a hash function to generate a hash value, which is unique to a finite number of root certificates. When the root certificate itself is used as an identifier Z of the root certificate, the root certificate itself is stored in the identifier database and the resource database. When a hash value of the root certificate is used as an identifier Z of the root certificate, the hash value of the root certificate is stored in the identifier database and the resource database.

1. A mobile terminal characterized by comprising:
application storage means for storing application software programs to be used;
resource list request means for requesting a resource list including resources that can be accessed by an application software program stored in the application storage means to an external device based on information indicative of a root certificate used to verify a certificate attached to the application software program at predetermined timing of use of the application software program; and
resource access control means for determining a resource that can be accessed by the application software program with use of the resource list acquired by the request of the resource list request means.

2. A mobile terminal characterized by comprising:
application storage means for storing application software programs to be used;
resource list acquisition means for transmitting an identifier of a root certificate used to verify a certificate attached to an application software program stored in the application storage means to a predetermined server at predetermined timing of use of the application software program and acquiring a resource list including resources that can be accessed by the application software program with use of a key of the identifier of the root certificate; and
resource access control means for determining a resource that can be accessed by the application software program with use of the resource list acquired by the resource list acquisition means.

3. The mobile terminal as recited in claim 2, characterized by further comprising an access database for storing resource lists corresponding to the respective application software programs; and access database update means for adding the resource list acquired from the server to the access database if the resource list acquired from the server has not been stored in the access database and for updating a corresponding resource list in the access database if the resource list acquired from the server has been stored in the access database.

4. A resource access control system for a mobile terminal, characterized by comprising:
a mobile terminal including application storage means for storing application software programs to be used, resource list request means for requesting a resource list including resources that can be accessed by an application software program stored in the application storage means to an external device based on an identifier of a root certificate used to verify a certificate attached to the application software program at predetermined timing of use of the application software program, and resource access control means for determining a resource that can be accessed by the application software program with use of the resource list acquired by the request of the resource list request means; and
a server including a resource database for storing resource lists including resources that can be accessed by various application software programs in association with an identifier of a root certificate, resource database retrieval means for performing retrieval from the resource database when the resource list request means of the mobile terminal requests a resource list with a specified identifier of a root certificate, and resource list transmission means for transmitting the resource list acquired by the retrieval of the resource database retrieval means to the requesting mobile terminal.

5. A resource access control method in a mobile terminal, characterized by comprising:
a resource list acquisition request step of transmitting an identifier of a root certificate used to verify a certificate attached to an application software program to a server at predetermined timing of use of the application software program in a mobile terminal and requesting acquisition of a resource list including resources that can be accessed by the application software program;
a retrieval result transmission step of retrieving a resource list from a resource database storing resource lists including resources that can be accessed by various application software programs in association with the respective application software programs with use of a key of the identifier of the root certificate transmitted in the resource list acquisition request step and transmitting the resource list from the server to the requesting mobile terminal; and
a resource access control step of determining a resource that can be accessed by the application software program with use of the resource list transmitted from the server to the mobile terminal in the retrieval result transmission step.

6. A mobile terminal characterized by comprising:
application storage means for storing application software programs to be used;
a database for storing pairs of an identifier of a root certificate used to verify a certificate attached to an application software program stored in the application storage means and a resource list including resources that can be accessed by the application software program in association with each other;
receiving means for receiving a pair of an identifier of a root certificate transmitted from an external device and a resource list including resources that can be accessed by an application software program;
database update means for updating the database when the identifier received by the receiving means is an identifier of a root certificate used to verify a certificate attached to the application software program stored in the application storage means;
retrieval means for retrieving a resource list corresponding to an identifier of a root certificate used to verify a certificate attached to an application software program from the database when the application software program is started; and
resource access control means for determining a resource that can be accessed by the application software program with use of the resource list retrieved by the retrieval means.

7. A resource access control system for a mobile terminal, characterized by comprising:
a server including a database for storing pairs of an identifier of a root certificate and a resource list including resources that can be accessed by an application software program in association with each other, and resource list change transmission means for transmitting a resource list to a predetermined destination together with the identifier of the root certificate when the resource list is changed; and
a mobile terminal including application storage means for storing application software programs to be used, a database for storing pairs of an identifier of a root certificate used to verify a certificate attached to an application software program stored in the application storage means and a resource list including resources that can be accessed by the application software program in association with each other, receiving means for receiving a pair of an identifier of a root certificate transmitted from the server and a resource list including resources that can be accessed by an application software program, database update means for updating the database when the identifier received by the receiving means is an identifier of a root certificate used to verify a certificate attached to the application software program stored in the application storage means, retrieval means for retrieving a resource list corresponding to an identifier of a root certificate used to verify a certificate attached to an application software program from the database when the application software program is started, and resource access control means for determining a resource that can be accessed by the application software program with use of the resource list retrieved by the retrieval means.
